(19) United States
(12) Patent Application Publication
(10) Pub. No.: US 2014/0305113 A1
(43) Pub. Date: Oct. 16, 2014

(54) Power Split Transmission for a Travel Drive and Method for Controlling the Transmission

(71) Applicant: Dana Rexroth Transmission Systems, Arco (TN) (IT)

(72) Inventors: Marianna Salaris, Nago-Torbole (IT); Dennis Moeller, Riva del Garda (IT)

(73) Assignee: Dana Rexroth Transmission Systems, Arco (TN) (IT)

(21) Appl. No.: 14/248,946

(22) Filed: Apr. 9, 2014

(30) Foreign Application Priority Data
Apr. 12, 2013 (EP) 13163445.3

(51) Int. Cl. F16H 47/07

(52) U.S. Cl. CPC F16H 47/07; F16H 2702/06
USPC 60/327; 60/423

(57) ABSTRACT

A power split transmission includes a hydraulic power branch having two hydraulic machines arranged in a hydraulic circuit, at least one of which comprises an adjustable displacement. The transmission comprises a control device for controlling the transmission ratio, and is configured to actuate at least the one adjusting device at a displacement setting. The displacement setting is adjusted in relation to a displacement setting oriented to a current demand, at least in a drive mode or drive mode section in which the displacement of one of the hydraulic machines reaches a maximum or is reduced from this maximum.

This application claims priority under 35 U.S.C. §119 to patent application no. EP 13 16 3445.3, filed on Apr. 12, 2013 in the European Patent Office, the disclosure of which is incorporated herein by reference in its entirety.

The disclosure relates to a power split transmission for a travel drive, and to a method for controlling the transmission.

### BACKGROUND

Besides a mechanical power branch, which can be operated with a fixed or variable transmission ratio, power split transmissions of generic type for a travel drive, in particular that of a mobile machine, for example a wheeled loader, comprise a further power branch. The latter is embodied as a hydraulic transmission branch having a hydraulic pump and a hydraulic motor in the form of a closed hydraulic circuit. Here the hydraulic pump, at least, has an adjustable displacement, so that the overall transmission ratio of the power split transmission is continuously variable by way of the hydraulic transmission branch. The hydraulic motor may be designed with an adjustable or a constant displacement.

Power outputs of the two power branches can be combined by way of a summing transmission section of the transmission, often embodied as planetary gearing, and transmitted to a transmission output, for example an output shaft of the transmission. In addition the power branches can be coupled or are coupled to a prime mover of the travel drive, for example an internal combustion engine, preferably a diesel engine, by way of a transmission input, in particular a transmission input shaft.

Here an adjustment of the displacement of the hydrostatic units, oriented to current demand, is performed by way of a preferably electro-hydraulic adjustment device. For this purpose this device can be subjected to a control fluid by way, for example, of a solenoid-actuated proportional directional-control valve. For this, the valve is actuated by a control device of the transmission or the travel drive at a displacement setting varying as a function of the current demand. A speed of travel is requested by way of an accelerator pedal, for example, which is actuated by an operator, and which in turn is connected to the control device. For the hydraulic pump and possibly for the hydraulic motor, said device determines a setting for the displacement of each adjustable hydraulic machine, on the basis of the request and kinematic equations of the transmission, of the inverse kinematic. The current vehicle speed is fed back to the control device via a rotational speed sensor.

Power split transmissions of generic type are shown, for example, by the published patent applications DE 10 2007 037 107 A1 and DE 10 2007 037 664 A1. These have multiple drive modes. A purely hydraulic drive mode prevails when only the hydraulic power branch is involved in transmitting power between the input shaft and the output shaft of the transmission, bypassing the mechanical power branch. Conversely a purely mechanical drive mode exists when only the mechanical power branch is involved. If both power branches are involved in the transmission of power, the drive mode is classed as a power split drive mode.

In vehicle acceleration, the vehicle passes through successive drive modes, and within the drive modes through drive mode sections. For driving away, a first, purely hydrostatic drive mode is preferably selected. Here, with the aim of maximizing driveaway torque during a first drive mode section, the adjustable hydraulic motor is first set to its maximum displacement, which is kept constant, whilst the displacement of the hydraulic pump, always oriented by the control device previously described to the current demand according to the required speed, is increased from a minimum, in particular from zero. Once the displacement of the hydraulic pump reaches a maximum, a change ensues from the first drive mode section into a second drive mode section of the hydrostatic drive mode. In this section the control device thereafter keeps the displacement of the hydraulic pump constant, whilst the latter serves to reduce the displacement of the hydraulic motor, oriented by the control device previously described to the current demand, according to the required speed.

On attaining a suitable shift criterion, the mechanical branch is connected to the summing transmission section by way of a clutch, so that a power split drive mode is selected and a third drive mode section ensues. In this section a further increase in the speed or the transmission ratio can be achieved, depending on the concept of the summing transmission section, for example by increasing the capacity and/or reducing the volumetric delivery of one or both hydraulic machines. Further transmission stages may be coupled to the two power branches in order to form further drive modes.

A disadvantage to the known solutions is that in transitions between drive modes or transitions between drive mode sections, in which one of the hydraulic machines experiences a change from the constantly maintained to the variably controlled displacement—or vice-versa—or in transitions in which a change occurs in the power flow direction of the transmission, less power is available, adversely affecting the driving dynamics. This is perceptible by the operator in the form of jerky driving, for example, or a discrepancy between the current and the required speed of travel. The reason for this lies, for example, in finite response times of the actuated hydraulic machine or a discontinuous transmission characteristic.

### SUMMARY

The object of the disclosure, by contrast, is to create a power split transmission for a travel drive having improved driving dynamics. A further object of the disclosure is to create a method for controlling such a transmission.

A power split transmission for a travel drive, in particular that of a wheeled loader, comprises a transmission input which can be coupled, in particular, to a prime mover of the travel drive and which comprises, in particular, an input shaft of the transmission. It furthermore comprises a transmission output, which can be coupled in particular to a wheel or axle unit of the travel drive and which comprises, in particular, an output shaft of the transmission. Here a transmission ratio of the transmission can be defined by rotational speeds of the input and the output. In terms of actual values for the rotational speed this relates, in particular, to an actual or current transmission ratio of the transmission. The transmission also comprises a hydraulic power branch having a first hydraulic machine, which can be coupled, in particular mechanically, to the transmission input, and a second hydraulic machine, which can be hydraulically connected to the former by way of a first working line and a second working line, and coupled to the transmission output. The working lines and the hydraulic machines thus form, in particular, a closed hydraulic circuit. Here at least one of the hydraulic machines comprises an adjusting device for adjusting its displacement. The transmission moreover comprises a further, in particular mechanical power branch, which can be coupled, in particular mechanically, to the transmission input and the transmission output. The transmission furthermore comprises a control device for controlling the transmission ratio. This is designed in such a way that it serves to actuate at least the one adjusting device at a displacement setting or a setting proportional thereto, which is adjusted in relation to a displacement setting oriented to a current demand, at least in a drive mode of the transmission in which the displacement of one of the hydraulic machines reaches an absolute or a local maximum, or is reduced from the maximum.

In one possible development of the transmission the current demand is a currently requested transmission ratio of the transmission or a currently requested speed of travel of the travel drive, either of which can be relayed to the control device.

The displacement setting adjusted in relation to the displacement setting oriented to the current demand affords the advantage that the transmission ratio and/or the speed of travel can be made to track the demand more dynamically and also more continuously. For an operator of the transmission or travel drive this makes itself felt in improved driving dynamics in the form of a more precise control of the transmission ratio and more comfortable driving, with the added effect of a more constant power consumption by the transmission with no surges.

The transmission preferably comprises more than one drive mode. The drive mode extends over a drive mode-specific interval of the transmission ratio. It may be unsplit, so that only one of the power branches contributes to the power transmitted by the transmission. Drive modes or their transmission ratio intervals may overlap or they may be separated from one another. A purely hydraulic drive mode of the transmission, in which the power is transmitted solely via the hydraulic power branch and the other power branch is decoupled, is particularly suitable, for example, for a working travel of the travel drive, in which only low speeds are required, although a drive torque must be precisely adjustable over wide ranges. A power split or a purely mechanical drive mode, on the other hand, is mainly suitable for driving with limited dynamics in terms of the speed of travel and tractive force, or with a virtually constant operating point.

If the power branches can be selectively connected to the transmission via clutches of the transmission, a defined circuit diagram of the clutches corresponds to each drive mode. The drive mode can then be changed, for example, by actuating or releasing at least one of the clutches.

A drive mode comprises either just one or multiple drive mode sections, by means of which the transmission ratio interval of the drive mode is divided into multiple sections. If it comprises just the one drive mode section, the drive mode section extends over its entire drive mode.

A drive mode section is defined, for example, in that in this section the actual displacement of only one of the hydraulic machines is variable, whereas the other is constant. Another drive mode section may be defined in that in this section the actual displacement of both hydraulic machines is variable.

In order to determine at least the adjusted displacement setting, and preferably likewise to determine the displacement setting oriented to the demand, the control device in one possible development comprises a memory unit, in which a method (as described further below] can be stored. It may furthermore comprise a processor unit for performing the method.

The control device is preferably designed in such a way that for receiving the demand it can be signal-connected to a set-point adjuster of the transmission or the travel drive by way of a signal line, in particular via a bus system, or wirelessly connected, in particular via WLAN.

If the transmission is used in a travel drive, the set-point adjuster is preferably embodied as an accelerator pedal or joystick of the travel drive.

In a preferred development both hydraulic machines each comprise an adjusting device, which in a known manner can be actuated via the control device at a prevailing displacement setting, which is adjusted in relation to the displacement setting oriented to the current demand, at least in the one drive mode of the transmission.

In this case fulfillment of the demand can be controlled with particular flexibility by the control device.

Alternatively, the transmission may be designed in such a way that only the first hydraulic machine comprises the adjusting device and the second hydraulic machine is designed with a constant displacement. The mechanisms in this variant are particularly simple.

In an especially advantageous development of the transmission the control device is designed in such a way that it serves to adjust one or both of the displacement settings at least as a function of the drive mode of the transmission and/or of the actual transmission ratio (r) and/or of a power flow direction of the transmission and/or of a working pressure of the working lines and/or of a working pressure limit of the working lines and/or of a transmission input speed and/or of a fluid temperature.

This adjustment is a correction of the one or both displacement settings as a function of process parameters of the transmission, which makes it possible to minimize the residual deviation of the transmission ratio from the required transmission ratio. For the operator, this also again results in the aforementioned improvement in the driving dynamics and more precise control of the transmission ratio and the speed of travel.

The control device is more preferably designed in such a way that it serves to vary the displacement setting(s) as a function of all seven said parameters: drive mode, transmission ratio, power flow direction, working pressure, working pressure limit, transmission input speed and fluid temperature.

The power may be susceptible to summation in a summing transmission section of the transmission to form an output power at the transmission output. The transmission may be of input-coupled design, in which the branching can be formed by a geared stage and the summing transmission section by a planetary gearing. In this case a fixed speed ratio prevails on the branching and a fixed torque ratio on the summation. Alternatively, the transmission may be of output-coupled design, in which the branching is embodied by a planetary gearing and the summing transmission section by a geared stage. A fixed torque ratio then prevails on the branching and a fixed speed ratio on the summation. Alternatively, the transmission may have a mixed architecture based on these concepts.

The power flow direction may be positive or negative. It is defined as positive if a mechanical power is absorbed by the transmission input, transmitted via the power branch(es) to the transmission output and delivered by the latter. In this case a tractive condition occurs on the travel drive. Where power is absorbed on the transmission output and power is delivered on the transmission input, it is defined as negative, so that an overrun condition prevails.

The control device may be designed in such a way that it serves to determine the displacement settings of both hydraulic machines—oriented to the demand or adjusted—by way of an inverse kinematic stored therein. For each of the drive modes this comprises at least one equation containing factors associated with the drive mode. The latter are equation constants which serve to map kinematics of the transmission. The two displacement settings determined in this way, at least one of which is adjusted, as already mentioned, consequently allow the control device to determine a transmission ratio of the hydraulic power branch.

The transmission may comprise external or internal power branching.

In a further advantageous development of the transmission the second hydraulic machine also comprises an adjusting device and the control device is designed in such a way that is serves to adjust the displacement setting of the second hydraulic machine at least in a first interval of the transmission ratio, in such a way that it is limited to a fraction of a maximum, in particular a maximum possible displacement setting of the second hydraulic machine.

The fraction is preferably 50% to 90%, more preferably 70% to 80% of the maximum possible displacement setting. The first interval preferably covers a predominant range of the transmission ratio, more preferably all possible defined transmission ratios and hence drive modes.

The advantage in limiting the setting to this fraction results from the following correlation: for a given load moment acting on the second hydraulic machine, the smaller displacement setting—and thereby the associated actual value—means that a higher working pressure results in the high-pressure working line than with an unlimited, maximum displacement setting. This is advantageous if the fluid in this working line is intended as control fluid source of the adjusting device of the second hydraulic machine. The higher the working pressure, the higher the control pressure that can be derived from this. The higher control pressure in turn results in a greater speed of adjustment for the second hydraulic machine, so that the residual deviation of the transmission ratio from the required transmission ratio or demand can be minimized. For the operator, this here too again results in the aforementioned improvement in the driving dynamics and more precise control of the transmission ratio and the speed of travel.

A further advantage to this is that owing to the limited displacement setting of the second hydraulic machine, a range of the transmission ratio, in which this varies solely as a function of the adjustment of the first hydraulic machine, is increased. A more uniform, steadier control of the transmission ratio can thereby be achieved.

In conventional power split transmissions, on the other hand, the displacement setting of the second hydraulic machine is unlimited and is then 100% of the maximum possible displacement setting, if the first hydraulic machine is actuated by the control device at its displacement setting oriented to the demand. According to the preceding description the lower control pressure and the lower speed of adjustment of the second hydraulic machine, and high residual deviation are thereby disadvantageously linked.

A further advantage lies in the increased working pressure in a range in which the volumetric efficiencies of the hydraulic machines are higher, and therefore relatively smaller losses occur in the transmission of power.

In a further advantageous development of the transmission the control device is designed in such a way that it serves to actuate adjusting devices of both hydraulic machines, which are intended for adjusting their displacements, more or less simultaneously, in particular independently of one another.

This simultaneous actuation makes it possible to compensate for dead times or the response time of one or both hydraulic machines, resulting in a more continuous and more stable profile of the transmission ratio and thereby of the speed of travel.

The control device here is preferably designed in such a way that the displacement settings of the hydraulic machines can have gradients other than zero with different signs, at least in a second interval of the transmission ratio, especially one corresponding to the dead time.

This means, therefore, that whilst one of the hydraulic machines, for example, is actuated with the displacement setting still rising, the other is actuated with the displacement setting already falling, or vice-versa.

In an especially advantageous development of the transmission the control device is designed in such a way that it serves to adjust the displacement setting in relation to the displacement setting oriented to the current demand, at least as a function of a dead time or response time of one of the hydraulic machines.

This is advantageous particularly in drive modes in which, in order to adjust the transmission ratio, for example when increasing it during an acceleration, the displacement setting of one of the two hydraulic machines is intended to shift from a variably controlled to a constant value, and the displacement setting of the other of the two hydraulic machines is conversely intended to shift from a constant to a variably controlled value.

In conventional power split transmissions, in such drive modes the other of the two hydraulic machines is actuated only from a transmission ratio at which the displacement or the displacement setting of the one hydraulic machine has reached the so-called constant value, that is to say sequentially. During the then elapsing dead time of the other hydraulic machine there is at first no further change in the transmission ratio, which in driving can be perceived as a jerk. This adversely affects the driving sensation of an operator and the precision of the travel drive. Only when the dead time has elapsed does the displacement setting of the other hydraulic machine take effect, so that the adjustment of the transmission ratio can proceed further.

By contrast, the actuation mentioned, as a function of the dead time, allows an earlier actuation at a future displacement setting of the other hydraulic machine. In other words, the displacement setting of the other hydraulic machine is revised in relation to the current demand as a function of the dead time, in such a way that it corresponds to the displacement setting of a future or anticipated demand or required transmission ratio. This means that the moment the one hydraulic machine reaches its constant value, the dead time of the other hydraulic machine has already elapsed and the displacement of the latter hydraulic machine shifts from the constant to the variably controlled value, resulting in a continuous, stable profile of the transmission ratio and the speed of travel without perceptible jerking.

The control device is preferably designed in such a way that it serves to adjust the displacement setting in relation to the displacement setting oriented to the current demand not only as a function of the dead time or response time but moreover at least as a function of a rate of adjustment or a gradient of the transmission ratio.

In one embodiment the control device is designed in such a way that the second interval comprises extreme values of the displacement settings of the hydraulic machines.

An embodiment is furthermore possible in which the control device is designed in such a way that the second interval comprises extreme values of actual values of the displacements.

It is possible here for the control device to be designed in such a way that the extreme values of the actual values are located on a boundary of the second interval.

The hydraulic machine is preferably designed as an axial piston machine of swash plate or inclined axis type. In this case the displacement is proportional to a swivel angle of the swash plate or inclined axis.

A method for controlling the transmission ratio of a power split transmission, which is designed according to one or more aspects of the preceding description, comprises at least the steps:

determination of the displacement setting, adjusted in relation to the displacement setting oriented to the demand, for at least one hydraulic machine” and “actuation of the adjusting device of at least the one hydraulic machine at the displacement setting adjusted in this way”.

This method affords the same advantages as have already been described for the device for the power split transmission: the transmission ratio of the transmission and/or the speed of travel of the travel drive can be made to track the demand more dynamically and also more continuously. For an operator of the transmission or travel drive this makes itself felt in improved driving dynamics and moreover in a more precise control of the transmission ratio and the speed of travel and smoother and hence more comfortable driving.

In a preferred development of the method the step “determination of the displacement setting, adjusted in relation to the displacement setting oriented to the demand, for at least the one hydraulic machine” is performed at least as a function of the drive mode, that is to say indirectly or directly as a function of the transmission ratio, and/or of the transmission ratio and/or of a power flow direction of the transmission and/or of a working pressure of the working lines and/or of a working pressure limit of the working lines and/or of a transmission input speed (n_{E}) and/or of a fluid temperature.

The advantages of this determination and actuation as a function of said parameters are set forth in the preceding description.

Here the displacement setting(s) is/are preferably determined as a function of all seven said parameters: drive mode, transmission ratio, power flow direction, working pressure, working pressure limit, transmission input speed and fluid temperature.

The method preferably comprises a step “determination of the displacement settings of both hydraulic machines via equations of an inverse kinematic”, the inverse kinematic having already been described in the preceding description.

Provided that the second hydraulic machine also comprises the adjusting device, in an advantageous development of the method the step “determination of the displacement setting, adjusted in relation to the displacement setting oriented to the demand, for the second hydraulic machine” is performed at least in a first interval of the transmission ratio at least via a step “limiting of the displacement setting to a fraction of a maximum or maximum possible displacement setting.

The adjustment here is performed via a limiting of the displacement setting. As already mentioned, the fraction is preferably 50% to 90%, more preferably 70% to 80% of the maximum possible displacement of the second hydraulic machine, and the first interval covers a predominant range of the transmission ratio, more preferably all possible defined transmission ratios and hence drive modes and drive mode sections.

The advantage of this limitation is also set forth in the preceding description.

Provided that both hydraulic machines comprise an adjusting device, in an advantageous development the step “actuation of the adjusting device of at least the one hydraulic machine at the displacement setting adjusted in this way” is performed more or less simultaneously, in particular independently of one another, with a step “actuation of the adjusting device of the other hydraulic machine at a displacement setting”. The latter can likewise be adjusted according to the disclosure or oriented to the demand.

Here it is advantageous if the method is designed in such a way that in a second interval of the transmission ratio, corresponding in particular to the dead time, the displacement settings of both hydraulic machines can have gradients other than zero with different signs. Then, whilst one of the hydraulic machines, for example, is actuated with the displacement setting still rising, the other is actuated with the displacement setting already falling, or vice-versa.

Provided that both hydraulic machines comprise an adjusting device, the step “determination of the displacement setting, adjusted in relation to the displacement setting oriented to the demand, for at least one hydraulic machine” is performed particularly advantageously at least as a function of the dead time or response time of one of the hydraulic machines.

### BRIEF DESCRIPTION OF THE DRAWINGS

An exemplary embodiment of a transmission according to the disclosure and three exemplary embodiments of methods according to the disclosure for controlling the transmission are explained in more detail below with reference to ten figures, of which:

FIG. 1 shows a hydraulic circuit diagram of an exemplary embodiment of a power split transmission of a travel drive,

FIG. 2a shows a displacement-transmission ratio diagram of a conventional method for controlling the transmission according to FIG. 1,

FIG. 2b shows a displacement-transmission ratio diagram of a first exemplary embodiment of a method for controlling the transmission according to FIG. 1,

FIG. 3a shows a flow chart of a second exemplary embodiment of a method for controlling the transmission according to FIG. 1,

FIG. 3b shows a calculation of a hydrostatic efficiency compensation of the method according to FIG. 3a,

FIG. 3c shows a calculation of an inverse kinematic of the method according to FIGS. 3a and 3b,

FIG. 4a shows profiles of correction factors in performing the method according to FIGS. 3a to 3c and a method for dead time compensation for controlling the transmission according to FIG. 1,

FIG. 4b shows pressure profiles correlating with FIG. 4a,

FIG. 4c shows a swivel angle-time diagram, correlating with FIGS. 4a and 4b, with swivel angle settings and swivel angle actual values, and

FIG. 4d shows a transmission ratio-time diagram, correlating with FIGS. 4a, 4b and 4c, with a setting and an actual value of the transmission ratio.

For easier orientation, the same reference numerals are hereinafter used for the same or similar components appearing in the various figures.

### DETAILED DESCRIPTION

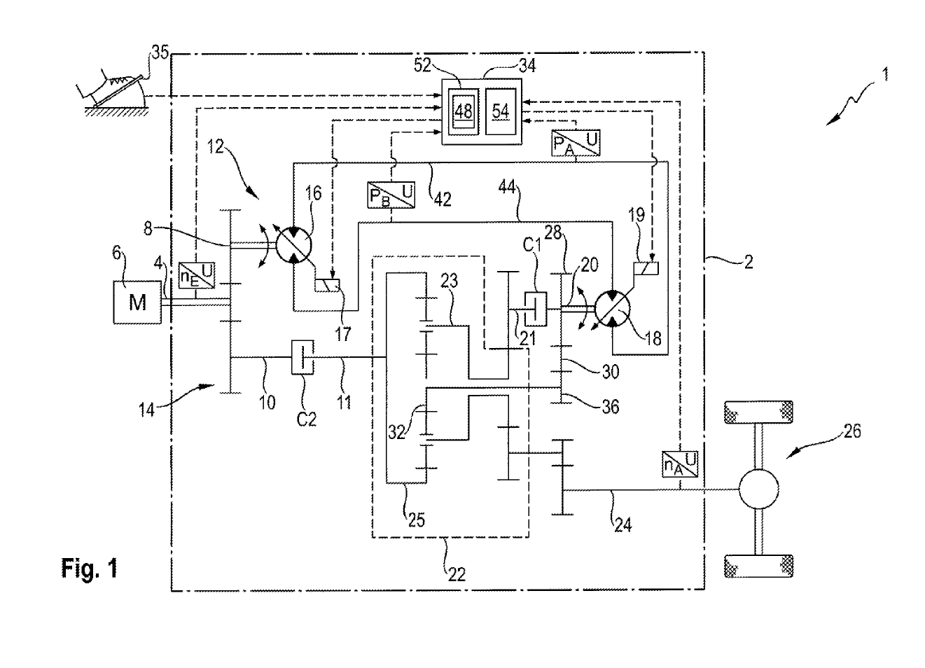

According to FIG. 1 a power split transmission 2 is provided in a travel drive 1 of a vehicle, for example a front loader. This transmission 2 comprises a transmission input having an input shaft 4, which is connected to a drive engine or a prime mover 6. The input shaft 4 is connected to each of the input shafts 8, 10 by way of gear wheels. The input shaft 8 is assigned to a hydraulic, first power branch 12 and the input shaft 10 is assigned to a mechanical, second power branch 14. The hydraulic power branch 12 comprises an adjustable, first hydraulic machine 16, embodied as a hydraulic pump, designed for delivery in two directions, and an adjustable, second hydraulic machine 18, likewise designed for delivery in both directions of flow but embodied as a hydraulic motor. Both are embodied as axial piston machines and are hydraulically connected to one another in a closed hydraulic circuit via a first working line 42 and a second working line 44, the first hydraulic machine 16 in this exemplary embodiment being of swash plate type and the second hydraulic machine 18 of inclined axis type. Alternative embodiments and different combinations of the two types are naturally also possible. It is to be emphasized that both hydraulic machines can be operated in pump and in engine mode.

For adjusting their respective displacements each hydraulic machine 16, 18 comprises an adjusting device 17, 19. Both adjusting devices 17, 19 are connected by signal lines to a control device 34, which in turn is connected via a signal line to an accelerator pedal 35. The control device 34 comprises a memory unit 52, in which a method 48 is stored for execution. The method 48 serves for controlling the displacements of the hydraulic machines 16, 18 and can be executed in a processor unit 54 of the control device 34.

The first hydraulic machine is driven by the prime mover 6 by way of the input shaft 8. The second hydraulic machine 18 comprises an output shaft 20. This shaft 20 may be connected via a first clutch C1 and a pair of gear wheels to a planet arm 23 of a single-stage planetary gearing, which serves to form a summing transmission section 22 of the transmission 2. A first engine gear wheel 28 is rotationally fixed to the output shaft 20 and by way of an intermediate gear wheel 30 drives a gear wheel 36, rotationally fixed to a sun gear 32 of the planetary gearing. Accordingly, the sun gear 32 is permanently driven in the direction of rotation of the hydraulic motor 18 and at a speed directly dependent upon the second hydraulic machine 18. When the clutch C1 is closed, the planet arm 23 is driven at a speed directly dependent upon the second hydraulic machine 18, the directions of rotation of the planet arm 23 and of the second hydraulic machine 18 being opposed to one another.

The input shaft 10 of the mechanical power branch 14 may be connected by way of a second clutch C2 to an input shaft 11 of the summing transmission section 22, which is rotationally fixed to an internal ring gear 25. An output speed of the planet arm 23 is set by the speeds of the sun gear 32 and the internal ring gear 25 of the summing transmission section 22. The rotation of the planet arm 23 is transmitted to the output shaft 24 of the transmission by means of further gear wheels.

For a more detailed description of the construction of the travel drive 1 and the transmission 2 and for the purpose of disclosure, reference should be made at this juncture to the published patent applications DE 10 2007 037 107 A1 and DE 10 2007 037 664 A1.

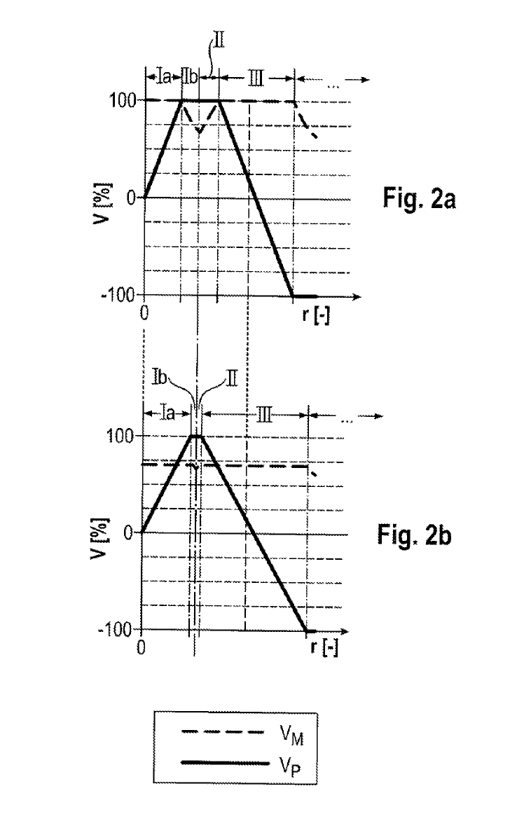

A first exemplary embodiment of a method according to the disclosure for controlling the transmission 2 is described with reference to FIGS. 1 and 2b, whilst FIG. 2a, which shows the profiles of displacements of the hydraulic machines 16, 18 using a conventional method for controlling the transmission 2, serves merely to illustrate the effect of the control according to the disclosure. The description here is confined to drive mode sections Iₐ, I_{b} and II sufficient for an understanding of the disclosure. The principle is correspondingly transferable to all other drive mode sections.

FIG. 2a shows the profile of the actual value of the displacement v_{P} of the first hydraulic machine 16 over the transmission ratio r as a solid curve. It further shows the profile of the actual value of the displacement v_{M} of the second hydraulic machine 18 as a dashed curve. The axis of the transmission ratio r is divided into four different drive mode sections Iₐ, I_{b}, H and HI. In a first drive mode section Iₐ the first hydraulic machine 16, starting from a displacement 0, is adjusted towards its maximum displacement (100%). For this purpose it is actuated by the control device 34 according to FIG. 1 at a variable displacement setting v_{Ps} (not shown). In this drive mode Iₐ the displacement v_{M} of the second hydraulic machine 18 constantly exhibits its maximum value (100%). The moment the displacement v_{P} also reaches its maximum value (100%), a further increase in the transmission ratio r is possible only through a reduction of the displacement v_{M} of the hydraulic motor 18. For this purpose the control device 34 according to FIG. 1 shifts from the hitherto prevailing variable actuation of the first hydraulic machine 16 or hydraulic pump to a variable actuation of the second hydraulic machine 18 or the hydraulic motor. For this purpose the latter is actuated by the control device 34 according to FIG. 1 at a variable displacement setting v_{Ms} (not shown). Thus according to FIG. 2a from the drive mode I_{b} onwards the displacement v_{M} is reduced, which results in the increasing transmission ratio r. According to the conventional control method the two hydraulic machines 16, 18 are therefore actuated purely sequentially at a variable displacement setting v_{Ps}, v_{Ms} and the hydraulic motor 18 begins to adjust its swivel angle only when the hydraulic pump 16 has reached 100% of its displacement, and vice-versa.

According to the conventional control method according to FIG. 2a the second hydraulic machine or the hydraulic motor 18 therefore has its maximum displacement v_{M} in the drive mode sections Iₐ, III and any further drive mode sections with higher transmission ratios r. Accordingly the associated displacement setting v_{Ms} (not shown) is likewise at a maximum. The conventional control using the maximum displacement of the second hydraulic machine 18 here corresponds to a control oriented purely to the current demand.

It should be noted that a purely hydrostatic, unsplit drive mode is formed over the drive mode sections Iₐ and I_{b}.

FIG. 2b also shows a sequential actuation of the two hydraulic machines 16, 18. In contrast to the conventional control according to FIG. 2a on the other hand, the displacement setting v_{Ms} of the second hydraulic machine 18 is adjusted in relation to its displacement setting oriented to the demand, at least in the drive mode sections Iₐ, I_{b}, II and III, by limiting it to a fraction. Here the method 48 filed in the memory unit 52 and executable in the processor unit 54 is used. Here, over the range of the transmission ratio r covered by these drive mode sections, the fraction is 70% of the maximum possible displacement, for example, that is to say in this case it is adjusted by at least −30% of that oriented to the demand. As already explained in the general part of the description, this results in a higher working pressure p_{AB}, depending on the direction of rotation and the power flow direction P_{+/-} either in the working line 42 or 44, resulting in the improved speed of adjustment and therefore dynamically in a smaller residual deviation from the required transmission ratio rₐ. For the operator, this affords the advantage of a more precise and dynamic control of the travel drive 1 and the transmission 2. The notion that limiting the displacement setting v_{Ms} of the second hydraulic machine 18, here to 70%, reduces its influence on the control of the transmission ratio r, can be seen from the fact that drive mode sections I_{b}, II and any other drive mode sections with a higher transmission ratio r, in which the transmission ratio r results solely from the variable actuation of the second hydraulic machine 18 are narrower according to FIG. 2b than in the case of conventional control according to FIG. 2a. Accordingly the influence of the first hydraulic machine 16 is increased and the drive mode sections Iₐ and II assigned to it are widened. This affords the advantage, already mentioned, that the transmission ratio can be controlled more dynamically, more uniformly and more steadily over wide ranges.

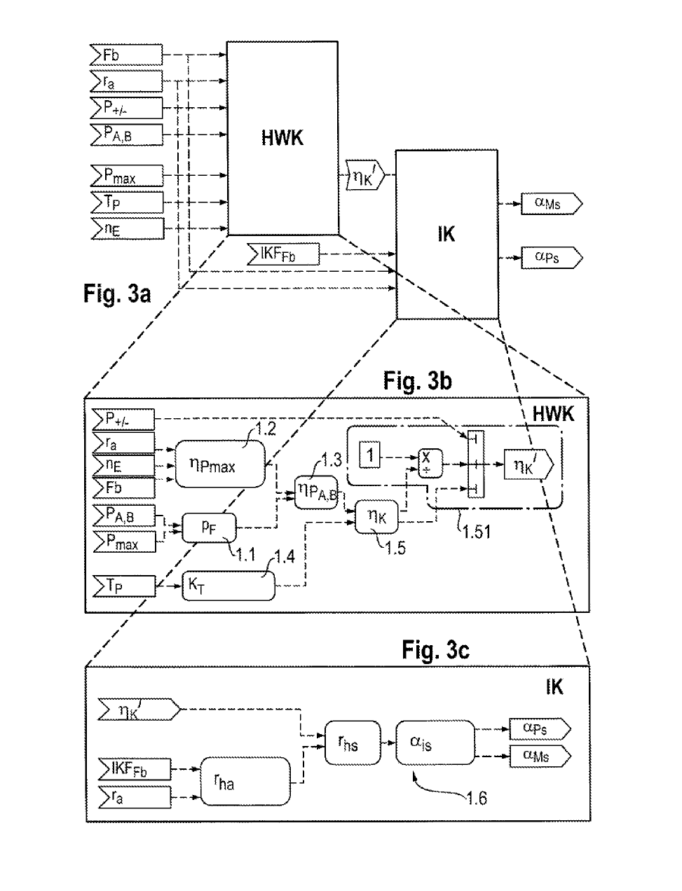

FIGS. 3a to 3c show a second exemplary embodiment of a method for controlling the transmission according to FIG. 1. The aim of the method is to determine two displacement settings in the form of two set-point values of swivel angles α_{Ms}, α_{Ps} of the hydraulic motor 18 and the hydraulic pump 16. The method here proceeds in two phases. In a first phase, the so-called hydraulic efficiency compensation HWK, a correction factor η′_{K} is calculated as a function of the drive mode Fb, of the required transmission ratio rₐ, of a power flow direction P_{+/-}, of a current working pressure p_{A,B} in the loaded working line 42 or 44, of the maximum admissible working pressure pₘₐₓ, of the oil or sump temperature Tₚ and of the transmission input speed n_{E}. Below the correction factor η′_{K} calculated is fed together with kinematic factors of the drive mode IKF_{FB}, the drive mode Fb and the required transmission ratio rₐ into the calculation of the inverse kinematic IK. The latter represents a second phase of the method. The inverse kinematic IK supplies the swivel angle settings α_{Ms} and α_{Ps} corresponding to the displacement values v_{Ms} and v_{Ps}.

FIG. 3b shows the detailed calculation process of the hydraulic efficiency compensation HWK, FIG. 3c shows that of the inverse kinematic IK. The equations employed here are:

p_{F}=p_{A,B}/pₘₐₓ Equation 1.1

ηₙₚₘₐₓ=f(rₐ,n_{E},P_{+/-}) Equation 1.2

η_{pA,B}=f(p_{F},ηₚₘₐₓ) Equation 1.3

K_{T}=f(Tₚ) Equation 1.4

η_{K}=η_{pA,B}*K_{T} Equation 1.5

η′_{K}=f(P_{+/-},η_{K}) Equation 1.51

rₕₛ=rₕₐ*η′_{K} Equation 1.6

where:
p_{F} is the pressure factor, varying as a function, for example, of the transmission ratio r, required speed, required power
p_{A,B} is the current working pressure in working line 42 or 44
pₘₐₓ is the maximum working pressure in working line 42 or 44
ηₚₘₐₓ is the maximum correction factor; determined from pre-calculated tables and scaled as a function of the pressure factor P_{F}
rₐ is the required transmission ratio
n_{E} is the current transmission input speed on the input shaft 4
P_{+/-} is the power flow direction
η_{pA,B} is the correction factor for current working pressure p_{A,B}
K_{T} is the temperature correction factor
Tₚ is the fluid or sump temperature
η_{K} is the temperature-dependent correction factor
η′K is the correction factor
rₕₛ is the corrected transmission ratio (corrected set-point value) of the hydraulic power branch 12
rₕₐ is the required transmission ratio (required set-point value) of the hydraulic power branch 12
αᵢₛ is the swivel angle ratio setting
α_{Ps} is the swivel angle setting of the first hydraulic machine 16
α_{Ms} is the swivel angle setting of the second hydraulic machine 18

As already mentioned in the preceding general description, this correction serves to reduce a residual deviation of the transmission ratio r from the required transmission ratio rₛ, taking into account the volumetric and mechanical efficiency of the hydraulic machines, which for the operator results in the increased driving dynamics already mentioned and more precise control of the transmission ratio and the speed of travel.

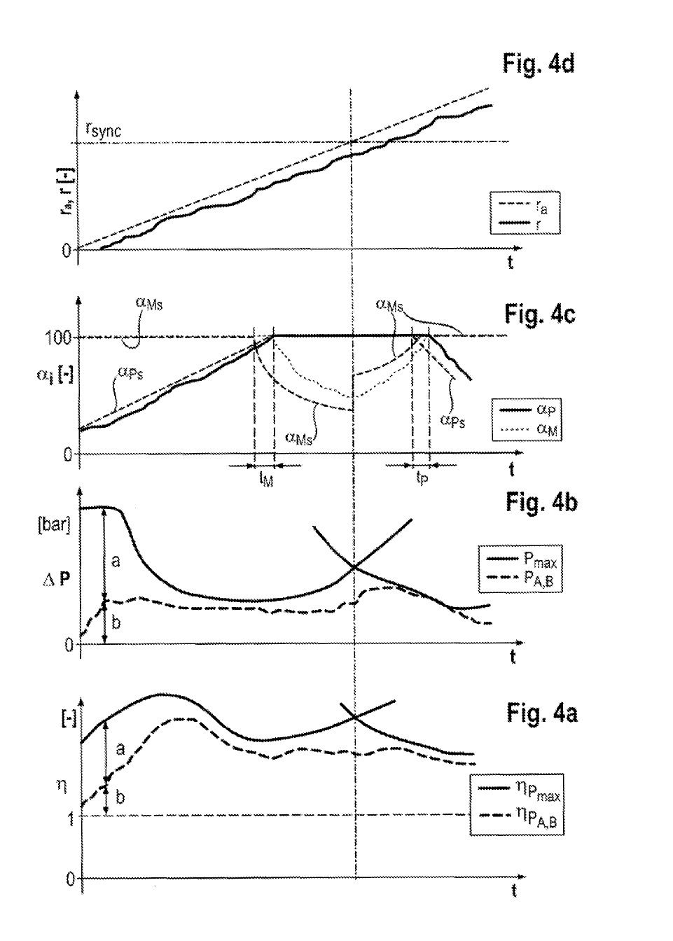

FIGS. 4a to 4d now show further diagrams, which represent the effect of the method already demonstrated and the effect of a further exemplary embodiment of the method, of a dead time compensation on the control of the transmission ratio r.

FIG. 4d shows the profile of the actual transmission ratio r as a solid curve and above this the profile of the required transmission ratio rₐ as a function of the time t. It can easily be seen that the actual value of the transmission ratio r always has a residual deviation from the required transmission ratio rₐ, which is nevertheless small compared to the prior art.

FIG. 4c shows a profile of swivel angle settings α_{Ps} and α_{Ms} of the hydraulic pump 16 and the hydraulic motor 18 corresponding to displacement settings v_{Ps}, v_{Ms}. As already explained for FIGS. 3a to 3c, owing to the type of hydraulic machines 16, 18 the swivel angle settings α_{Ps} and α_{Ms} are proportional to the displacement settings v_{Ps}, v_{Ms}. FIG. 4c clearly shows how an exemplary embodiment of a control method according to the disclosure contributes to a gentler and more continuous profile of the transmission ratio in the transitional area from a drive mode section with purely variable actuation of the hydraulic pump 16 to a drive mode section with a purely variable actuation of the hydraulic motor 18, and vice-versa.

From time t=0 onwards the swivel angle setting α_{Ms} of the hydraulic motor 18 has a value of 100%, whereas the swivel angle setting α_{Ps} of the hydraulic pump 16 rises continuously. The control of the transmission ratio is based in this drive mode section, that is to say at first, solely on the variable actuation of the hydraulic pump 16. In a dead time interval t_{M} of the hydraulic motor 18, which corresponds to a response time of the hydraulic motor 18 to a setting signal, both hydraulic machines 16, 18 are now actuated simultaneously by the control device 34 with a variable displacement setting v_{Ps}, v_{Ms}. Here the control device 34 according to FIG. 1 advances the actuation of the hydraulic motor 18 by the dead time t_{M}. Ideally this means that when the dead time t_{M} has elapsed the actual value αₚ of the swivel angle of the hydraulic pump 16, represented as a closed curve, reaches its maximum value of 100% and at the same time the actual value of the swivel angle of the hydraulic motor 18 (dotted) departs from its maximum value of 100% and is reduced.

Looking at the profile of the actual transmission ratio r in FIG. 4d at this point in time, no plateau in the profile of the transmission ratio r is to be seen at this point. The control taking the dead time t_{M} into account therefore contributes to a harmonization and precision of the control behavior of the transmission ratio r. A similar behavior is apparent at the transition of the control in the area of the dead time interval tₚ, where a similar shift occurs from the purely variable actuation of the hydraulic motor 18 with its setting α_{Ms} to the variable actuation of the hydraulic pump with its setting α_{Ps}. The dead time t_{P} here corresponds to the response time of the hydraulic pump 16 to a setting signal. The dead times t_{M}, Tₚ may have different values and are machine-specific parameters.

FIG. 4b shows the curve profile of the maximum admissible working pressure pₘₐₓ and the actual working pressure p_{A,B}. In the diagram the line segments are marked a and b. FIG. 4b in principle shows both operands of the equation 1.1 described with reference to FIGS. 3a to 3c. The value pₘₐₓ here corresponds to the sum of the line segments a+b and the value of the working pressure p_{A,B} corresponds to the line segment b.

FIG. 4a shows the profile of the correction factors ηₚₘₐₓ and η_{pA,B}. Here the influence of the sump temperature Tₚ is disregarded, it being assumed to be constant. This results in a K_{T} of 1.

A power split transmission is disclosed with a hydraulic power branch having two hydraulic machines arranged in a hydraulic circuit, at least one of which is designed with an adjustable displacement. The transmission here comprises a control device for controlling the transmission ratio, which is designed in such a way that it serves to actuate at least the one adjusting device at a displacement setting, which is adjusted in relation to a displacement setting oriented to a current demand, at least in a drive mode or drive mode section in which the displacement of one of the hydraulic machines reaches a maximum or is reduced from this maximum.

A method is furthermore disclosed for controlling the transmission ratio of such a transmission, which serves to determine the displacement setting adjusted in relation to the displacement setting oriented to the demand, and to actuate at least the one adjusting device at the displacement setting adjusted in this way.

### LIST OF REFERENCE NUMERALS

1 travel drive
2 transmission
4 input shaft
6 prime mover
8 input shaft, hydraulic power branch
110 input shaft, mechanical power branch
11 input shaft, summing transmission section
12 hydraulic power branch
14 mechanical power branch
16 first hydraulic machine
17 adjusting device
18 second hydraulic machine
19 adjusting device
20 output shaft
21 input shaft
22 summing transmission section
23 planet arm
24 output shaft
25 internal ring gear
26 axle unit
28 first engine gear wheel
30 intermediate gear wheel
32 sun gear
34 control device
35 accelerator pedal
36 gear wheel
42,44 first working line, second working line
48 method
52 memory unit
54 processor unit
C1,C2 first clutch, second clutch

What is claimed is:

1. A power split transmission for a travel drive, comprising:
a transmission input;
a transmission output, wherein rotational speeds of the transmission input and transmission output define an actual transmission ratio of the power split transmission;
a hydraulic power branch that includes:
a first hydraulic machine coupled to the transmission input; and
a second hydraulic machine hydraulically connected to the first hydraulic machine via a first working line and a second working line, and coupled to the transmission output;
wherein at least one of the first hydraulic machine and the second hydraulic machine includes an adjusting device that is configured to adjust a displacement of the at least one of the first hydraulic machine and the second hydraulic machine;
a further power branch coupled to the transmission input and the transmission output; and
a control device configured to control the actual transmission ratio, configured such that the control device actuates at least the adjusting device at a displacement setting which is adjusted in relation to a displacement setting oriented to a current demand, at least in a drive mode of the transmission in which the displacement of one of the first hydraulic machine and the second hydraulic machine reaches a maximum or is reduced from the maximum.

2. The power split transmission of claim 1, wherein the first hydraulic machine comprises the adjusting device and the second hydraulic machine comprises a second adjusting device configured to be actuated by the control device at a displacement setting which is adjusted in relation to the displacement setting oriented to the current demand, at least in the drive mode.

3. The power split transmission of claim 1, wherein the control device is configured to adjust the displacement setting of at least the adjusting device based on a function of at least one of:
the drive mode;
the actual transmission ratio;
a power flow direction of the power split transmission;
a working pressure limit of the first working line and the second working line;
a fluid temperature; and
the rotational speed of the transmission input.

4. The power split transmission of claim 1, wherein:
the second hydraulic machine comprises the adjusting device; and
the control device is configured to adjust the displacement setting of the second hydraulic machine at least in a first interval of the actual transmission ratio such that the second hydraulic machine is limited to a fraction of a maximum displacement setting.

5. The power split transmission of claim 2, wherein the control device is configured to actuate the adjusting device and the second adjusting device substantially simultaneously.

6. The power split transmission of claim 1, wherein the control device is configured such that the displacement setting is defined by a non-zero gradient with a first sign in a first interval of the actual transmission ratio and a second sign different from the first sign during a second interval of the actual transmission ratio.

7. The power split transmission of claim 1, wherein the control device is configured to adjust at least the displacement setting at least as a function of a dead time or response time of one of the first hydraulic machine and the second hydraulic machine.

8. A method for controlling a transmission ratio of a power split transmission, comprising:
determining a displacement setting, adjusted in relation to a displacement setting oriented to a demand, for at least one of:
a first hydraulic machine coupled to a transmission input of the power split transmission; and
a second hydraulic machine hydraulically connected to the first hydraulic machine via a first working line and a second working line, and coupled to a transmission output of the power split transmission;
wherein rotational speeds of the transmission input and transmission output define the transmission ratio; and
wherein at least one of the first hydraulic machine and the second hydraulic machine includes an adjusting device that is configured to adjust a displacement of the at least one of the first hydraulic machine and the second hydraulic machine; and
actuating the adjustment device at the displacement setting.

9. The method according to claim 8, wherein determining the displacement setting is performed as a function of at least one of:
a drive mode of the power split transmission;
a power flow direction of the power split transmission;
the transmission ratio;
a working pressure of one of the first working line and second working line;
a fluid temperature; and
a speed of the transmission input.

10. The method according to claim 8, wherein:
the first hydraulic machine and second hydraulic machine each comprise one of the adjusting device; and
determining the displacement setting is performed in a first interval of the transmission ratio at least via limiting of the displacement setting for the second hydraulic machine to a fraction of a maximum displacement setting.

11. The method according to claim 8, wherein the first hydraulic machine comprises the actuating device and the second hydraulic machine comprises a second adjusting device; and the method further comprises:
actuating the second adjusting device substantially simultaneously to actuating the adjusting device.

12. The method according to claim 8, wherein
the first hydraulic machine and second hydraulic machine each comprise one of the adjusting device; and
determining the displacement setting is performed at least as a function of:
a dead time of the first hydraulic machine or second hydraulic machine; or
a response time of the first hydraulic machine or second hydraulic machine.
